(19) United States
(12) Patent Application Publication
(10) Pub. No.: US 2013/0029614 A1
(43) Pub. Date: Jan. 31, 2013

(54) Systems, Methods, and Apparatuses for Negative-Charge-Pump-Based Antenna Switch Controllers Utilizing Battery Supplies

(71) Applicants: Changhyuk Cho, Roswell, GA (US); Jeongwon Cha, Duluth, GA (US); Minsik Ahn, Atlanta, GA (US); Chang-Ho Lee, Marietta, GA (US); Wyangmyong Woo, Cumming, GA (US); Jae Joon Chang, Duluth, GA (US)

(72) Inventors: Changhyuk Cho, Roswell, GA (US); Jeongwon Cha, Duluth, GA (US); Minsik Ahn, Atlanta, GA (US); Chang-Ho Lee, Marietta, GA (US); Wyangmyong Woo, Cumming, GA (US); Jae Joon Chang, Duluth, GA (US)

(73) Assignee: SAMSUNG ELECTRO-MECHANICS COMPANY, Gyunggi-Do (KR)

(21) Appl. No.: 13/194,325

(22) Filed: Jul. 29, 2011

(51) Int. Cl. H04B 1/44

(52) U.S. Cl. 455/83

(57) ABSTRACT

Systems, methods, and apparatuses may provide for antenna switch controllers. An example antenna switch controller may include: a plurality of antenna switches commonly connected to one or more antennas, where each of the plurality of antenna switches includes a plurality of stacked transistors, where one of the plurality of antenna switches is enabled when transmitting or receiving one or more radio frequency (RF) signals via the one or more antennas; a voltage generator that receives an external supply voltage from a battery, where the voltage generator generates an internal supply voltage, where the internal supply voltage remains constant despite fluctuations in the external supply voltage from the battery; a clock buffer that generates clock signals from the constant internal supply voltage; and a charge pump that receives the clock signals and generates a constant negative voltage, where the constant negative voltage is for biasing of one or more of the plurality of antenna switches that are disabled.

### FIELD OF THE INVENTION

Embodiments of the invention relate generally to antenna switch controllers, and more particularly, to negative-charge-pump-based antenna switch controllers utilizing battery supplies.

### BACKGROUND OF THE INVENTION

As wireless communication evolves, there is an increased demand to support multiple standards in a single cellular device. Each standard can require multiple power amplifiers (PAs) and low noise amplifiers (LNAs) in order to cover multiple bands. Because those PAs and LNAs may have to transmit and receive a radio frequency (RF) signal through a shared antenna, an antenna switch is an essential component for selecting a communications block for transmission or reception of an RF signal. Accordingly, a multi-port antenna switch is the one of the key building blocks in the RF front-end circuits for multi-standard cellular devices.

As the market drives integration of multiple standards and multiple bands into a single device, the complexity of the control scheme increases as does requirements for antenna switch performance. However, conventional technologies used for antenna switches such as GaAs pHEMT and silicon-on-sapphire (SOS) are expensive and have significant disadvantages in integration. Accordingly, there is an opportunity for systems, methods, and apparatuses for negative charge-pump-based antenna switch controllers utilizing battery supplies.

### BRIEF SUMMARY OF THE INVENTION

According to an example embodiment, there is a CMOS antenna switch controller. The antenna switch controller may include a plurality of antenna switches commonly connected to one or more antennas, where each of the plurality of antenna switches includes a plurality of stacked transistors, where one of the plurality of antenna switches is enabled when transmitting or receiving one or more radio frequency (RF) signals via the one or more antennas; a voltage generator that receives an external supply voltage from a battery, wherein the voltage generator generates an internal supply voltage, where the internal supply voltage remains constant despite fluctuations in the external supply voltage from the battery; a clock buffer that generates clock signals from the constant internal supply voltage; and a charge pump that receives the clock signals and generates a constant negative voltage, where the constant negative voltage is for biasing of one or more of the plurality of antenna switches that are disabled.

According to another example embodiment, there is a method for an antenna switch controller. The method may include providing a plurality of antenna switches commonly connected to one or more antennas, where each of the plurality of antenna switches includes a plurality of stacked transistors, where one of the plurality of antenna switches is enabled when transmitting or receiving one or more radio frequency (RF) signals via the one or more antennas; receiving, by the voltage generator, an external supply voltage from a battery, and generating a respective internal supply voltage, wherein the internal supply voltage remains constant; generating, by a clock buffer, clock signals from the constant internal supply voltage; and receiving, by a charge pump, the clock signals and generating a constant negative voltage, wherein the constant negative voltage is for biasing one or more of the plurality of antenna switches that are disabled.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example block diagram of a radio frequency (RF) communications system having a plurality of RF antenna switch blocks and an antenna switch controller, according to an example embodiment of the invention.

FIG. 2 illustrates an example CMOS antenna switch 201 utilizing stacked transistor switches, according to an example embodiment of the invention.

FIG. 3A illustrates a block diagram of an example main negative charge pump block, according to an example embodiment of the invention.

FIG. 3B illustrates a block diagram of an example sub negative charge pump block, according to an example embodiment of the invention.

FIG. 4A illustrates an example schematic for an example output driver 401, according to an example embodiment of the invention.

FIG. 4B illustrates example input control signals and corresponding output voltages for the example output driver of FIG. 4A, according to an example embodiment of the invention.

FIG. 5 illustrates the schematic of an example main negative charge pump circuit, according to an example embodiment of the invention.

### DETAILED DESCRIPTION OF THE INVENTION

Embodiments of the invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the invention may provide systems, methods, and apparatuses for negative-charge-pump-based antenna switch controllers utilizing battery supplies. Example antenna switch controllers may be fabricated using various silicon-based processes, including silicon-on-insulator (SOI) processes utilizing SOI substrates. In addition, example antenna switch controllers may utilize complementary metal-oxide-semiconductor (CMOS) technology. Likewise, example antenna switch controllers can control multiple transmit (TX) and/or receive (RX) switches with an antenna, thereby providing for single pole multiple throw (SPMT) antenna switch controllers. Accordingly, example antenna switches in accordance with example embodiments of the invention may be referred to as CMOS SPMT antenna switch controllers.

Example CMOS SOI RF antenna switch controllers in accordance with embodiments of the invention may provide for one or more of the following features: multi-band operation, high power level handling, and integration with other devices and circuits. In an example embodiment of the invention, a CMOS SOI RF antenna switch controller may be integrated with a plurality of receiver (RX) switches and/or transmitter (TX) switches. Example antenna switch controllers may generate stable and constant internal supply voltages and negative voltages from a varying supply voltage available from a battery supply, according to an example embodiment of the invention. As an example, an antenna switch controller may include one or more output drivers to provide constant control voltages to example antenna switch blocks, thereby providing for high RF performance. In an example embodiment of the invention, an example RF switch controller can be operated from a battery because its power supply can vary within a range, perhaps 3.0V to 5.0V, without performance degradation of the antenna switches and without any transistor reliability problems, according to an example embodiment of the invention.

It will be appreciated that the switch controller can provide at least three constant control voltage levels to one or more example antenna switches in accordance with an example embodiment of the invention. For example, these constant control voltage levels can include a negative voltage, a zero voltage, or a positive voltage. A negative voltage can be utilized to turn off an example antenna switch, as described herein. For example, during a transmit (TX) mode when one of the antenna switches is active, one or more other antenna switches may be turned off using an example negative voltage provided from the switch controller. The use of a negative voltage can ensure that the transistors in the off-state antenna switches remain off even with large RF signals being transmitted to the antenna.

On the other hand, in some embodiments, an antenna switch may be turned off using a zero voltage from the switch controller. For example, during a receive (RX) mode when one of the antenna switches is active, one or more other antenna switches may be turned off using an example zero voltage provided from the switch controller. In this case, the zero voltage may be sufficient because the RF signals being received may be relatively small, and are thus unlikely to disrupt any of the off-state transistors in the off-state antenna switches.

In addition, in some embodiments, an antenna switch may be turned on using a positive voltage from the switch controller. For example, when an antenna switch is active during either a TX mode or an RX mode, the transistors of the antenna switch may be turned on using the positive voltage for the switch controller, thereby providing a main signal path between the antenna and the respective transmit or receive blocks, according to an example embodiment of the invention.

It will be appreciated that the example antenna switches and the antenna switch controllers described herein are by way of example only. Many variations of these antenna switches and antenna switch controllers are available without departing from example embodiments of the invention.

Example Antenna Switch Controller

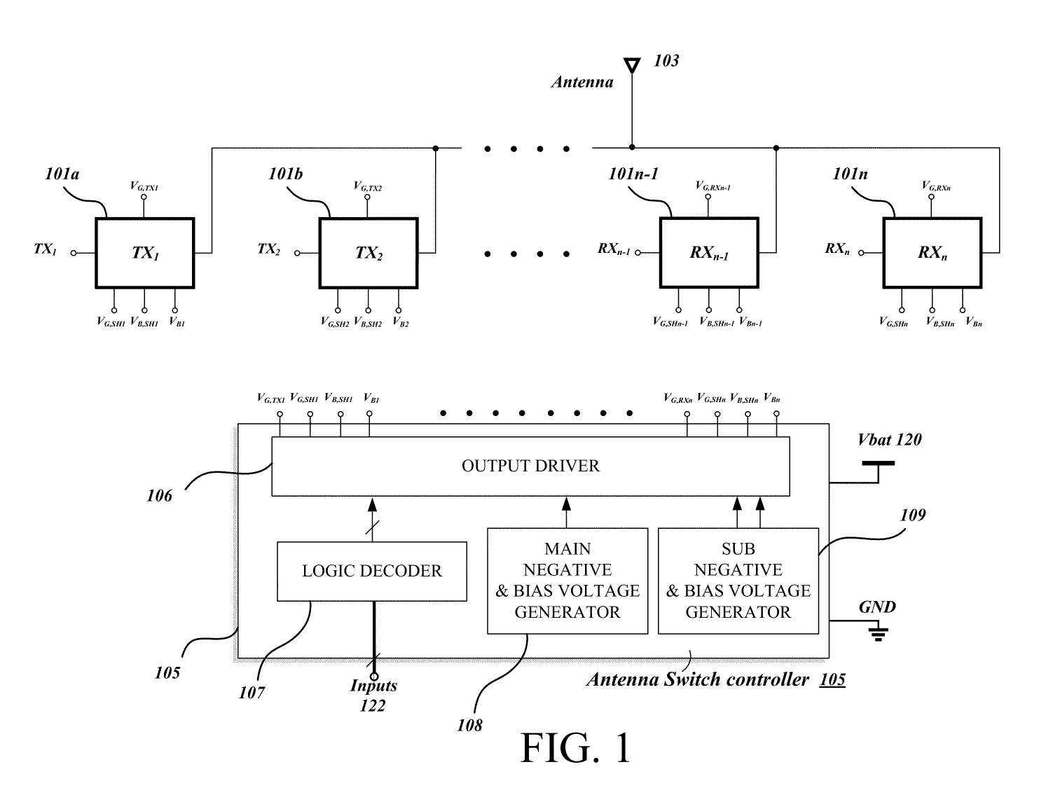

An RF CMOS antenna switch controller in accordance with an example embodiment of the invention now will be described in further detail with reference to FIGS. 1-3.

FIG. 1 illustrates an example block diagram of a radio frequency (RF) communications system 100 having a plurality of RF antenna switch blocks 101a-n that are in communication with, and controlled by, an antenna switch controller 105. Each of the plurality of RF antenna switch blocks 101a-n may be configured as one or both of a transmit (TX) antenna switch block or a receive (RX) antenna switch block. It will be appreciated that a respective first port of each of the plurality of RF antenna switch blocks 101a-n may be connected to an antenna 103. Likewise, a respective second port of each of the plurality of RF antenna switch blocks 101a-n may be connected a respective TX or RX block that is configured to generate TX signals for transmission or RX signals for reception.

In general, the plurality of antenna switch blocks 101a-n may include at least one TX antenna switch block or at least one RX antenna switch block. For example, as shown in FIG. 1, antenna switch blocks 101a, 101b may be TX antenna switch blocks while antenna switch blocks 101n-1, 101n may be RX antenna switch blocks. A TX antenna switch block can be enabled (ON) or activated by the antenna switch controller 105 to enable or allow a transmit block to deliver a transmit RF signal to the antenna 103. On the other hand, an RX antenna switch block can be enabled (ON) or activated by the antenna switch controller 105 to enable or allow a receive block to receive an RF signal from the antenna 103. In an example embodiment of the invention, the antenna switch controller 105 may operate only one of the antenna switch blocks 101a-n with an antenna 103 at a particular time. For example, if TX antenna switch block 101a were enabled (ON) to allow a transmit block to deliver a transmit signal TX₁ to the antenna 103, the other antenna switch blocks 101b-n may be disabled (OFF). Similarly, if RX antenna switch block 101n were enabled (ON) to allow a receive block to receive a signal RXₙ from the antenna 103, the other antenna switch blocks 101a-n-1 may be disabled (OFF). It will be appreciated that any of the antenna switch blocks 101a-n in FIG. 1 could alternatively operate as one or both of a TX block and an RX block without departing from example embodiments of the invention. Likewise, each of the antenna switch blocks 101a-n may be associated with respective communications standards and/or frequency bands, according to an example embodiment of the invention. For example, each of the antenna switch blocks 101a-n can support transmission or reception of respective GSM, EDGE, WCDMA, 3G, 4G, or other wireless signals without departing from example embodiments of the invention.

As introduced above, an example antenna switch controller 105 can control the operations of the antenna switch blocks 101a-n, including enabling (turning ON) or disabling (turning OFF) the antenna switch blocks 101a-n. In general, the antenna switch controller 105 can receive a battery voltage (Vbat) 120, for example, from the battery of a cellular phone or other mobile device. Responsive to logic inputs 122 indicating a mode of operation (e.g., TX or RX and associated standard), the antenna switch controller 105 can generate a plurality of stable and constant DC control voltages (e.g., V_{G,TX1-n}, V_{G,SH1-n}, V_{n,SH1-n}, V_{B1-n}) for controlling each of the antenna switch blocks 101a-n. It will be appreciated that maintaining stable and constant DC control voltages in view of a potentially fluctuating battery voltage (Vbat) 120 may be needed to ensure that one or more antenna switch blocks 101a-n remain in their desired mode of operation (e.g., enabled or disabled). For example, maintaining stable and constant DC control voltages can ensure that certain antenna switch blocks 101a-n remain disabled (OFF), when another antenna switch block 101a-n is enabled (ON) to deliver or receive large RF signals using the antenna 103. In an example embodiment, the example DC control voltages can remain stable and constant in the range of substantially 3.0V-5.0V, although other ranges, for example 2.5V-5.0V, can be supported without departing from example embodiments of the invention. In an example embodiment of the invention, one or more of control voltages can be a negative voltage, a zero voltage, or a positive voltage, as described herein.

The example antenna switch controller 105 of FIG. 1 may include one or more output drivers 106, a logic decoder 107, a main negative and bias voltage generator block 108, and a sub negative and bias voltage generator block 109, according to an example embodiment of the invention. In an example embodiment of the invention, the one or more output drivers 106 may be configured to provide respective DC control voltages—including positive, negative, and zero voltages—to respective antenna switch blocks 101a-n. It will be appreciated that there may be a plurality of output drivers 106 for respective DC control voltages for each of the plurality of antenna switch blocks 101a-n. Alternatively, a single output driver 106 may be provided to respective DC control voltages to two or more of the plurality of antenna switch blocks 101a-n, according to an example embodiment of the invention.

The logic decoder 107 may provide control signals to operate the output driver 106 to provide various DC control voltages to operate respective antenna switch blocks 101a-n. The main negative and bias voltage generator block 108 and the sub negative and bias voltage generator block 109 may provide supply voltages to support the output driver 106 in providing various DC control voltages, including positive, negative, and zero voltages, according to an example embodiment of the invention.

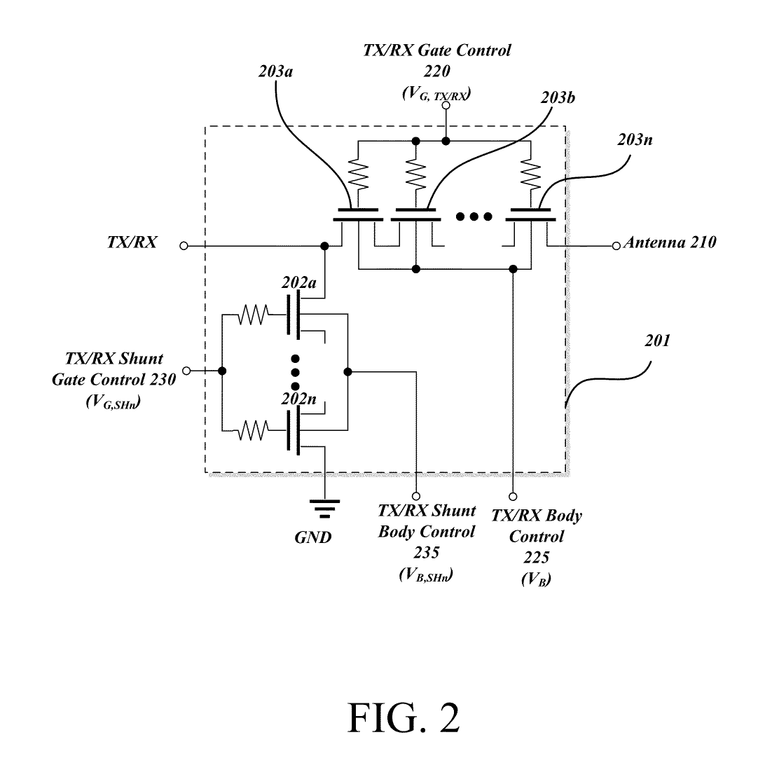

FIG. 2 illustrates an example CMOS antenna switch 201 utilizing stacked transistor switches, according to an example embodiment of the invention. The example antenna switch 201 may be utilized as an example implementation for any of the antenna switch blocks 101a-n of FIG. 1, according to an example embodiment of the invention. However, it will be appreciated that variations of the example CMOS antenna switch 201 can be utilized for any of the antenna switch blocks 101a-n without departing from example embodiments of the invention.

In FIG. 2, the example CMOS antenna switch 201 includes a first plurality of stacked transistor switches 203a-n that provide a main signal path between a TX/RX block and an antenna 210, which may be similar to the antenna 103 of FIG. 1. The plurality of transistor switches 203a-n may be stacked from source-to-drain such that the source of one transistor may be connected to a drain of an adjacent transistor. As an example, the drain of transistor switch 203a may be connected to the source of transistor switch 203b. Likewise, the source of transistor switch 203a may be connected to the TX/RX block while the drain of transistor switch 203n may be connected to the antenna 210. The stacking of the plurality of transistor switches 203a-n may help distribute voltage across the plurality of transistor switches 203a-n, thereby reducing the possibility of a source-to-drain breakdown voltage occurring for transistor switches 203a-n and increasing the power handling capability of the CMOS antenna switch 201. When the CMOS antenna switch 201 is enabled (ON), the plurality of transistor switches 203a-n may be in an ON-state (e.g., a closed switch) in order to provide a main signal path from the TX/RX block to the antenna 210. On the other hand, when the CMOS antenna switch 201 is disabled (OFF), the plurality of transistor switches 203a-n may be in an OFF-state (e.g., an open switch) in order to provide high impedance between the antenna 210 and the TX/RX block, thereby reducing leakage current from the antenna 210 to the TX/RX block.

In addition, the CMOS antenna switch 201 may include a plurality of stacked transistor switches 202a-n capable of selectively connecting the main signal path between a resistance and ground (GND). In FIG. 2, an end of the plurality of stacked transistor switches 202a-n may be connected to a node between the TX/RX block and transistor switch 203a. However, in an alternative embodiment of the invention, the plurality of stacked transistor switches 202a-n may be configured elsewhere along the main signal path, for example, to a node between the transistors 203a and 203b. The plurality of stacked transistor switches 202a-n may also be stacked from source-to-drain such that the source of one transistor may be connected to a drain of an adjacent transistor. In this way, the power handling capability of the plurality of stacked transistor switches 202a-n may be increased. When the CMOS antenna switch 201 is enabled (ON), the plurality of transistor switches 202a-n may be in an OFF-state (e.g., an open switch) in order to provide high impedance or an open circuit, and ensuring that the transmitted or received signal remains substantially on the main signal path between the TX/RX block and the antenna 210. On the other hand, when the CMOS antenna switch 201 is disabled (OFF), the plurality of transistor switches 202a-n may be in an ON-state (e.g., a closed switch), thereby creating a shunt path to ground for any leakage current in the main signal path, and providing further isolation between the TX/RX block and the antenna 210.

When transmitting a high power RF signal through one antenna switch block, it may be important to turn other switch blocks completely off to meet stringent RF switch linearity requirement. However, where the plurality of stacked transistor switches 203a-n comprise NMOS transistors, a zero voltage turn-off voltage for the transistor switches 203a-n may not be sufficient to meet linearity requirements. In this case, a negative turn-off voltage may be desired. Accordingly, the ON-state bias voltages for transistor switches 203a-n may be set to be a positive voltage (e.g., +2.3V) at the gate, and zero voltage (0V) at the body of transistor switches 203a-n. On the other hand, the OFF-state bias voltages for transistor switches 203a-n may be a negative voltage (e.g., −2.0V) for both the gate and body of the NMOS transistor. It will be appreciated that the output driver 106 can provide these control bias voltages as respective TX/RX gate control voltage 220 and a TX/RX body control voltage 225 to the respective gates and bodies of the plurality of transistor switches 203a-n. One of ordinary skill will appreciate that the example values of these negative, positive, and zero control bias voltages provided by the output driver 106 can be varied without departing from example embodiments of the invention.

With respect to the plurality of transistor switches 202a-n, the ON-state bias voltages for transistor switches 202a-n may be set to be a positive voltage (e.g., +2.3V) at the gate, and zero voltage (0V) at the body of transistor switches 202a-n. On the other hand, the OFF-state bias voltages for transistor switches 202a-n may be a negative voltage (e.g., −2.0V) for both the gate and body of the NMOS transistor. It will be appreciated that the output driver 106 can provide these control bias voltages as respective TX/RX shunt gate control voltage 225 and a TX/RX body control voltage 230 to the respective gates and bodies of the plurality of transistor switches 202a-n. One of ordinary skill will appreciate that the example values of these negative, positive, and zero control bias voltages provided by the output driver 106 can be varied without departing from example embodiments of the invention.

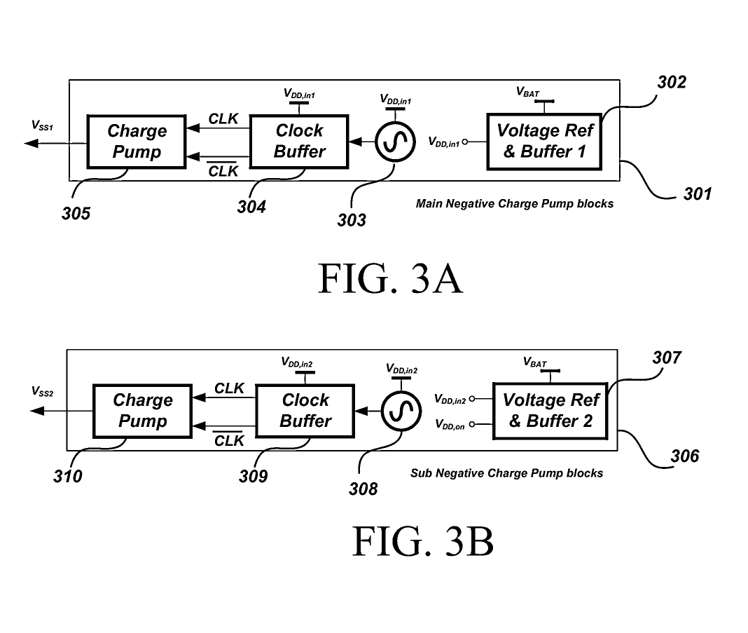

FIGS. 3A and 3B illustrate example block diagrams of respective main negative charge pump block 301 and sub negative charge pump block 306. The example main negative charge pump block 301 may be an example implementation of the main negative and bias voltage generator block 108 of FIG. 1. The sub negative charge pump block 306 may be an example implementation of the sub negative and bias voltage generator block 109 of FIG. 1. It will be appreciated that variations of the main negative charge pump block 301 and sub negative charge pump block 306 are available without departing from example embodiments of the invention.

Turning now to the FIG. 3A, an example main negative charge pump block 301 may include a main negative charge pump (MNCP) 305, a clock buffer 304, an oscillator 303, and a first voltage reference and buffer (VRB1) block 302, according to an example embodiment of the invention. In operation, the VRB1 block 302 may generate an internal supply voltage (V_{DD,in1}) having a constant supply voltage despite receiving varying direct supply voltage (V_{BAT}) from a battery. For example, the internal supply voltage (V_{DD,in1}) may remain constant even where the direct supply voltage (V_{BAT}) from a battery varies from 3.0V to 5.0V or another range. The constant internal supply voltage (V_{DD,in1}) from the VRB1 block 302 may be used as a supply voltage for the clock buffer 304 and oscillator 303. The oscillator 303 may generate an oscillation frequency for the clock buffer 304, which may then generate a first clock signal and a second clock signal, which may be 180 degrees out of phase from each other. The MNCP 305 may receive the two clock signals from the clock buffer 304 and generate a constant negative voltage V_{SS1}, which may be one of the negative supply voltages of the output driver 106, according to an example embodiment of the invention. Indeed, the output driver 106 may supply the constant negative voltage V_{SS1} as the TX/RX gate control voltage 220 in order to disable (turn OFF) an antenna switch 201. It will be appreciated that the output capacitor of the MNCP 305 may be large enough to drive the large gate capacitance of the antenna switch 201 (e.g., the stacked transistors 203a-n) and to be able to hold steady negative voltage when the high power RF signal is coming in or out of the antenna switch 201. For example, a TX/RX gate control voltage 220 may need to be a steady negative voltage to turn off an example antenna switch 201 when another antenna switch is transmitting a high power RF signal to the antenna 210 during a TX mode.

Turning now to FIG. 3B, an example sub negative charge pump block 306 may include a sub negative charge pump (SNCP) 310, a clock buffer 309, an oscillator 308, and a second voltage reference and buffer (VRB2) block 307, according to an example embodiment of the invention. The VRB2 block 307 may generate two constant voltages: a first internal supply voltage V_{DD,in2} and a second internal supply voltage V_{DD,on}. Again, the two voltages generated by the VRB2 block 307 may remain stable and constant despite a varying direct supply voltage (V_{BAT}) from a battery. For example, the internal supply voltages (V_{DD,in2} and V_{DD,on}) may remain constant even where the direct supply voltage (VBAT) from a battery varies from 3.0V to 5.0V or another range. The first internal supply voltage V_{DD,in2} may be used for a supply voltage of the clock buffer 309 and the oscillator 308. The oscillator 308 may generate an oscillation frequency for the clock buffer 309, which may then generate a first clock signal and a second clock signal, which may be 180 degrees out of phase from each other. The SNCP 310 may receive the two clock signals from the clock buffer 309 and generate a constant negative voltage V_{SS2}, which may be a negative supply voltage for the output driver 106, and in particular, for a level shifter of the output driver 106, as described herein. In a receive (RX) mode, the main negative charge pump block 301 can be disabled to save power consumption because a received RF signal may be small enough such that the negative voltage V_{SS1} may not be needed as TX/RX gate control voltage 220 in order to turn off an example antenna switch 201. For example, a TX/RX gate control voltage 220 of zero voltage may be provided to turn off an example antenna switch 201 when another antenna switch is operating during an RX mode to receive signals from the antenna 210.

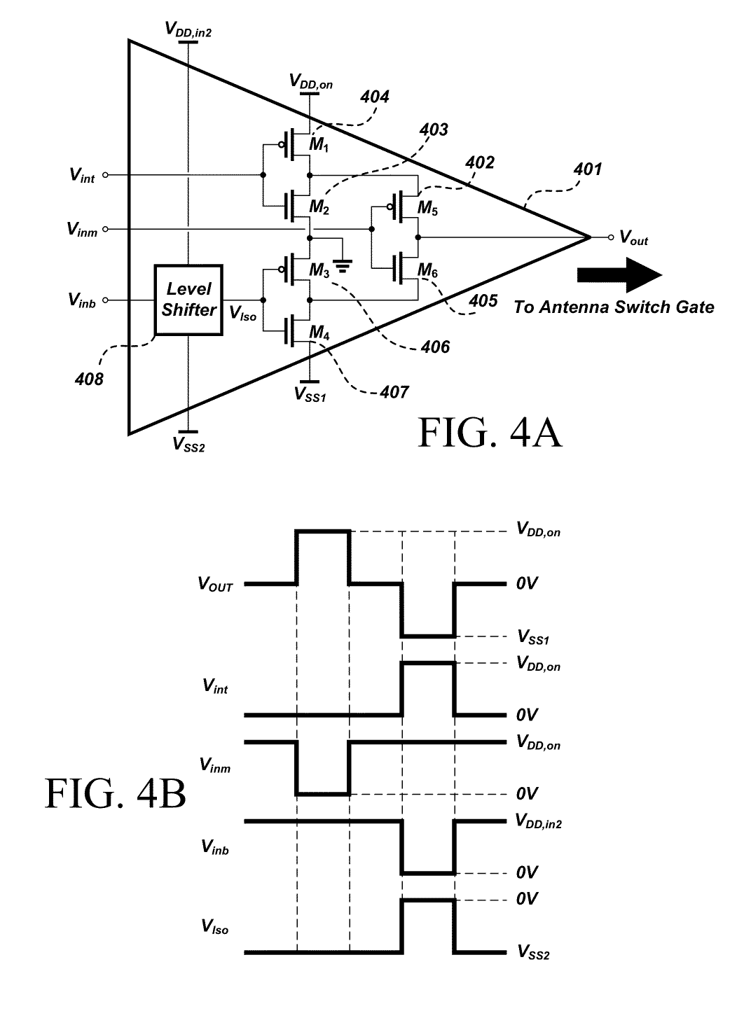

FIG. 4A illustrates an example schematic for an example output driver 401, according to an example embodiment of the invention. The example output driver 401 may be operable to output at least three DC supply voltage levels, including a negative voltage, a zero voltage, or a positive voltage. The example output driver 401 may be an example implementation for the output driver 106 of FIG. 1, although many variations of the example output driver 401 are available without departing from an example embodiment of the invention.

Turning now to FIG. 4A, the example output driver 401 may include a level shifter 408, PMOS transistors 402 (M5), 404 (M1), 406 (M3) and NMOS transistors 403 (M2), 405 (M6), 407 (M4). The example output driver 401 may receive control input signals (e.g., Vᵢₙₜ, Vᵢₙₘ, and V_{inb}) from a logic decoder such as logic decoder 107. The example output driver 401 can also receive two positive voltage supplies (e.g., V_{DD,in2}, V_{DD,on}) from the VRB2 block 307 of a sub negative charge pump block 306, as well as two negative supplies (e.g., Vₛₛ₁, Vₛₛ₂) from respective main negative charge pump block 301 and sub negative charge pump block 306. The example output driver 401 can provide one output voltage (Vₒᵤₜ), which can be controlled by the control input signals to be one of at least three voltage levels, including a positive, zero, or negative voltage level, according to an example embodiment of the invention.

In an example embodiment of the invention, transistors 403, 404 may be configured as a first CMOS switch; transistors 406, 407 may be configured as a second CMOS switch; and transistors 402, 405 may comprise a third CMOS switch.

The first CMOS switch comprising transistors 403, 404 may be connected between positive supply voltage V_{DD,on} and ground (0V). More specifically, the source of PMOS transistor 404 may be connected to the positive supply voltage V_{DD,on} while the source of NMOS transistor 403 may be connected to ground. The drains of transistors 404, 403 may be connected together to provide the output of the first CMOS switch. The gates of the transistors 404, 403 may likewise be connected together to provide the input of the first CMOS switch. In an example embodiment of the invention, the operation of the first CMOS switch may be controlled by the control input signal Vᵢₙₜ.

The second CMOS switch comprising transistors 406, 407 may be connected between ground (0V) and a negative supply voltage Vₛₛ₁. More specifically, the source of PMOS transistor 406 may be connected to ground (0V) while the source of NMOS transistor 407 may be connected to the negative supply voltage Vₛₛ₁. The drains of transistors 406, 407 may be connected together to provide the output of the second CMOS switch. The gates of the transistors 406, 407 may likewise be connected together to provide the input of the second CMOS switch. In an example embodiment of the invention, the operation of the second CMOS switch may be controlled by the control input signal V_{inb}, which is used by the level shifter 408 to derive the control input signal V_{ISO}. In an example embodiment of the invention, an example level shifter 408 may convert a positive control signal V_{inb} (from 0V to V_{DD,in2}) to a negative signal (from Vₛₛ₂ to 0V) for use as the control input signal V_{ISO}.

The third CMOS switch comprising transistors 402, 405 may be connected between the outputs of the first and second CMOS switches. More specifically, the source of PMOS transistor 402 may be connected to the output of the first CMOS switch while the source of NMOS transistor 405 may be connected to the output of the second CMOS switch. The drains of transistors 402, 405 may be connected together to provide the output of the third CMOS switch, which may likewise be the output voltage (Vₒᵤₜ)of the output driver 401. The gates of the transistors 402, 405 may likewise be connected together to provide the input of the third CMOS switch. In an example embodiment of the invention, the operation of the second CMOS switch may be controlled by the control input Vᵢₙₘ.

As shown in FIG. 4A, the output driver 401 may have access to two separate positive supplies: V_{DD,in2} and V_{DD,on}. In an example embodiment of the invention, the positive voltage supply V_{DD,on} may be appropriate for outputting as output voltage (Vₒᵤₜ) of the output driver 401, where the positive voltage supply V_{DD,on} may be used as a turn-on voltage of an antenna switch. For example, the positive voltage supply V_{DD,on} may be received as TX/RX gate control 220 in FIG. 2 to turn on the main signal path. Because V_{DD,on} may be used for turn-on voltage of an antenna switch, it may be free of any voltage ripple or noise. By contrast, since the positive voltage supply V_{DD,in2} may be employed for the supply voltage of the oscillator 308 and clock buffer 309, it may not be appropriate for use as a turn-on voltage in an antenna switch due to the presence of the small voltage ripples. Instead, the positive voltage supply V_{DD,in2} may be used by the level shifter 408 to convert a positive control signal V_{inb}, (from 0V to V_{DD,in2}) to a negative signal (from Vₛₛ₂ to 0V) for use as the control input signal V_{ISO} In this way, none of the adjacent nodes of the transistors in the output driver 401 may experience a voltage difference larger than the nominal voltage of the transistors.

FIG. 4B illustrates example input control signals and their corresponding output voltages for the example output driver 401 of FIG. 4A, according to an example embodiment of the invention. As shown in FIGS. 4A and 4B, in order to have a negative output voltage (e.g., Vₛₛ₁) from the output driver 401, the input control logic signals Vᵢₙₜ and Vᵢₙₘ should be high and the control logic signal V_{inb} should be low. As described with respect to FIG. 4A, the level shifter 408 not only converts output voltage level but inverts the logic input V_{inb}. As a result, NMOS transistor 403 (M2), NMOS transistor 407 (M4), and NMOS transistor 405 (M6) are turned-on and PMOS transistor 404 (M1), PMOS transistor 406 (M3), and PMOS transistor 402 (M5) are turned-off to generate a negative voltage at the output.

To have a positive output voltage (e.g., V_{DD,on}) from the output driver 401, the input control logic signals Vᵢₙₜ and Vᵢₙₘ should be low, and the control logic signal Vᵢₙₜ, should be equal to high. Recall, however, that the level shifter 408 not only converts the output voltage level but inverts the logic input V_{inb}. As a result, NMOS transistor 403 (M2), NMOS transistor 407 (M4), and NMOS transistor 405 (M6) are turned-off and PMOS transistor 404 (M1), PMOS transistor 406 (M3), and PMOS transistor 402 (M5) are turned-on to generate a positive voltage at the output.

To have a zero output voltage from the output driver 401, the input control logic signal Vᵢₙₜ should be low, and the control logic signals Vᵢₙₘ and V_{inb} should be equal to high. Recall, however, that the level shifter 408 not only converts the output voltage level but inverts the logic input V_{inb}. As a result, NMOS transistor 403 (M2), NMOS transistor 407 (M4), PMOS transistor 402 (M5) are turned-off, and PMOS transistor 404 (M1), PMOS transistor 406 (M3), and NMOS transistor 405 (M6) are turned-on to generate a positive voltage at the output.

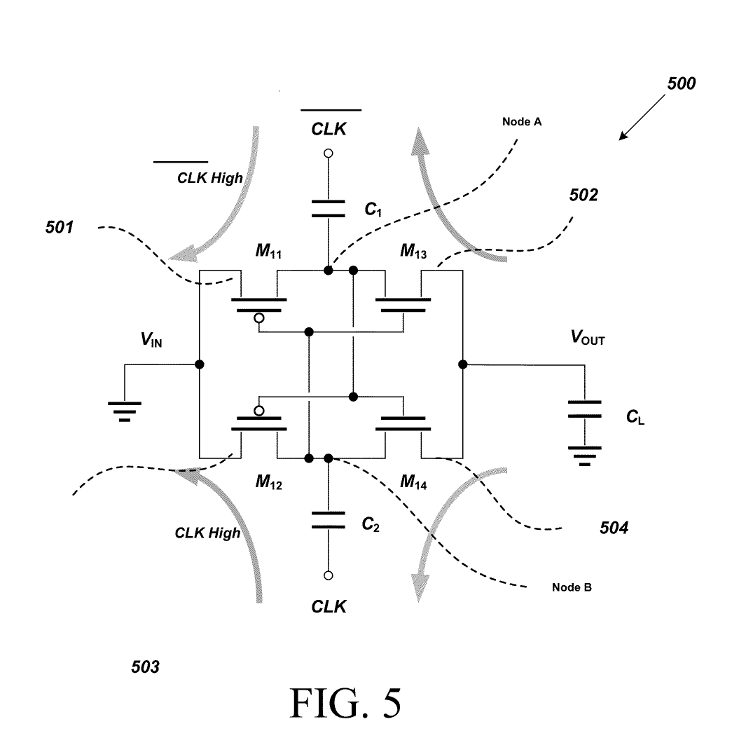

FIG. 5 illustrates a schematic of an example main negative charge pump circuit 500, according to an example embodiment of the invention. It will be appreciated that the negative charge pump circuit 500 may be an example implementation of the MNCP of FIG. 3, although many variations are available. In FIG. 5, the negative charge pump 500 may comprise PMOS transistors 501, 503; NMOS transistors 502, 504; and capacitors C₁, C₂, C_{L}. The non-overlapping clock signals for the negative charge pump circuit 500 may be provided from a clock buffer such as the clock buffer 304 of FIG. 3. The input of the negative charge pump circuit 500 (V_{IN}) may be connected to ground and the output (V_{OUT} may be connected to an output load capacitor (C_{L}) that may hold negative charges, according to an example embodiment of the invention.

When the clock signal CLK is high, PMOS transistor M₁₂ 503 and NMOS transistor M₁₃ 502 are turned on while PMOS transistor M₁₁ 501 and NMOS transistor M₁₄ 504 are turned off. The node B of the capacitor C₂ may be connected to ground and a negative charge having a value of C₂·V_{DD,in1} may be stored in the capacitor C₂. The node A of the capacitor C₁ may be connected to the output capacitor C_{L} and the negative charge may be moved from the capacitor C₁ to the output capacitor C_{L}.

The output voltage of the negative charge pump may be −V_{DD,in1} because the high output voltage of the clock signal CLK may be V_{DD,in1} from the VRB1 block 302. If a battery voltage (V_{BAT}) is used for the supply voltage of the clock buffer, the output voltage of the main negative charge pump may be −V_{BAT}. Because the battery voltage (VBAT) can change from 3.0V to 5.0V, the output voltage of a main negative charge pump can also change from −3.0V to −5.0V and this case should be avoided. For this reason, using V_{DD,in1} in FIG. 3A instead of V_{BAT} directly for the generation of the clock signals switching between 0 to V_{DD,in1} may be utilized, according to an example embodiment of the invention.

For an exemplary purpose, 2.5V may be set for the antenna switch device's nominal operation voltage. The negative voltage (Vₛₛ₁) from the charge pump 305 may be used for the turn-off voltage of the RF antenna switches and should stay between −1.5V and −2.5V for the best RF performance of the antenna switch. If Vₛₛ₁ is greater than −1.5V, the harmonic performance of the antenna switch is deteriorated. If Vₛₛ₁ is smaller than −2.5V, it will affect the antenna switch device's long-term reliability and even can cause device breakdown if it is much smaller than −2.5V. This is why a constant internal supply voltage is required for the antenna switch controller.

Many modifications and other embodiments of the invention set forth herein will come to mind to one skilled in the art to which these inventions pertain having the benefit of the teachings presented in the foregoing descriptions and the associated drawings. Therefore, it is to be understood that the inventions are not limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A CMOS antenna switch controller, comprising:
a plurality of antenna switches commonly connected to one or more antennas, wherein each of the plurality of antenna switches includes a plurality of stacked transistors, wherein one of the plurality of antenna switches is enabled when transmitting or receiving one or more radio frequency (RF) signals via the one or more antennas;
a voltage generator that receives an external supply voltage from a battery, wherein the voltage generator generates an internal supply voltage, wherein the internal supply voltage remains constant despite fluctuations in the external supply voltage from the battery;
a clock buffer that generates clock signals from the constant internal supply voltage; and
a charge pump that receives the clock signals and generates a constant negative voltage, wherein the constant negative voltage is for biasing of one or more of the plurality of antenna switches that are disabled.

2. The CMOS antenna switch of claim 1, wherein the constant negative voltage biases one or more respective gates of the plurality of stacked transistors when the respective antenna switch is disabled.

3. The CMOS antenna switch of claim 2, wherein the respective antenna switch is disabled when one of the other plurality of antenna switches is in a transmit (TX) mode or a receive (RX) mode.

4. The CMOS antenna switch of claim 1, further comprising:
at least one output driver, wherein the at least one output driver is configured to receive the constant negative voltage and to output the constant negative voltage for biasing the one or more of the plurality of antenna switches when disabled.

5. The CMOS antenna switch of claim 4, wherein the at least one output driver includes a level shifter for shifting a positive control voltage to the constant negative signal that is output for biasing the one or more of the plurality of antenna switches that are disabled.

6. The CMOS antenna switch of claim 4, wherein the voltage generator, the clock buffer, and the charge pump form a main negative charge pump block, and further comprising:
a sub negative charge block pump block that includes:
a second voltage generator that receives the external supply voltage from the battery, wherein the second voltage generator generates a second internal supply voltage, wherein the second internal supply voltage remains constant despite fluctuations in the external supply voltage from the battery;
a second clock buffer that generates second clock signals from the second constant internal supply voltage; and
a second charge pump that receives the second clock signals and generates a second constant negative voltage, wherein the second constant negative voltage is for biasing transistors of the output driver to enable the first constant negative voltage to be output by the output driver.

7. The CMOS antenna switch of claim 4, wherein the at least one output driver is further configured to supply a zero voltage or a constant positive voltage for biasing one or more of the plurality of antenna switches.

8. The CMOS antenna switch of claim 7, wherein the constant positive voltage provided for biasing the one or more of the plurality of antenna switches that are enabled

9. The CMOS antenna switch of claim 7, wherein the zero voltage is utilized during a receive (RX) mode for biasing one or more of the antenna switches that are not operating.

10. The CMOS antenna switch of claim 4, wherein the at least one output driver includes a plurality of PMOS transistors and NMOS transistors configured to respond to control signals by enabling the at least one output driver to output the constant negative voltage, the zero voltage, or the constant positive voltage.

11. The CMOS antenna switch of claim 10, further comprising:
a logic decoder for providing control signals to the at least one output driver, the control signals associated with a receive (RX) mode or a transmit (TX) for one or more of the plurality of antenna switches.

12. The CMOS antenna switch of claim 1, wherein the antenna switches, the voltage generator, the clock buffer, and the charge pump are fabricated using one or more silicon-based processes.

13. The CMOS antenna switch of claim 1, wherein the one or more silicon-based processes includes a silicon-on-insulator (SOI) process.

14. A method for a CMOS switch controller, comprising:
providing a plurality of antenna switches commonly connected to one or more antennas, wherein each of the plurality of antenna switches includes a plurality of stacked transistors, wherein one of the plurality of antenna switches is enabled when transmitting or receiving one or more radio frequency (RF) signals via the one or more antennas;
receiving, by the voltage generator, an external supply voltage from a battery, and generating a respective internal supply voltage, wherein the internal supply voltage remains constant;
generating, by a clock buffer, clock signals from the constant internal supply voltage; and
receiving, by a charge pump, the clock signals and generating a constant negative voltage, wherein the constant negative voltage is for biasing one or more of the plurality of antenna switches that are disabled.

15. The method of claim 14, further comprising:
providing at least one output driver, wherein the at least one output driver is configured to receive the constant negative voltage and to output the constant negative voltage for biasing the one or more of the plurality of antenna switches when disabled.

16. The method of claim 15, wherein the at least one output driver includes a level shifter for shifting a positive control voltage to the constant negative signal that is output for biasing the one or more of the plurality of antenna switches that are disabled.

17. The method of claim 15, wherein the voltage generator, the clock buffer, and the charge pump form a main negative charge pump block, and wherein the method further includes:
providing a sub negative charge block pump block that includes:
a second voltage generator that receives the external supply voltage from the battery, wherein the second voltage generator generates a second internal supply voltage, wherein the second internal supply voltage remains constant despite fluctuations in the external supply voltage from the battery;
a second clock buffer that generates second clock signals from the second constant internal supply voltage; and
a second charge pump that receives the second clock signals and generates a second constant negative voltage, wherein the second constant negative voltage is for biasing transistors of the output driver to enable the first constant negative voltage to be output by the output driver.

18. The method of claim 15, wherein the at least one output driver includes a plurality of PMOS transistors and NMOS transistors configured to respond to control signals by enabling the at least one output driver to output the constant negative voltage, the zero voltage, or the constant positive voltage.

19. The method of claim 18, further comprising:
providing, by a logic decoder, control signals to the at least one output driver, the control signals associated with a receive (RX) mode or a transmit (TX) for one or more of the plurality of antenna switches.

20. The method of claim 14, wherein the constant negative voltage biases one or more respective gates of the plurality of stacked transistors when the respective antenna switch is disabled.
